(19) United States
(12) Patent Application Publication
(10) Pub. No.: US 2025/0282012 A1
(43) Pub. Date: Sep. 11, 2025

(54) Tool Holder

(71) Applicant: Techniks, LLC, Indianapolis, IN (US)

(72) Inventor: Jared WALKER, Rochester, NY (US)

(21) Appl. No.: 18/601,111

(22) Filed: Mar. 11, 2024

(51) Int. Cl. B23Q 3/155

(52) U.S. Cl. CPC B23Q 3/15526; B23Q 2003/15532

(57) ABSTRACT

A plurality of coolant channels extending from a coolant reservoir in the first section of the tool holder in a counter-clockwise helical path around the bore to a circular channel extending three-hundred and sixty degrees around the bore with a plurality of equally spaced openings in the front face of the tool holding section extending at an angle to the circular channel.

### TECHNICAL FIELD

This disclosure relates to tool holders, and more specifically, this disclosure relates to a tool holder with internal coolant channels.

### BACKGROUND INFORMATION

A machine tool is a machine for shaping and machining metal or other rigid materials, usually by cutting, boring, grinding, shearing and other forms of deformation. Machining centers and lathes are the most common examples. A machining center, for example, is a computer numerical control (CNC) machining tool with an automatic tool-changing function. The machining center can automatically perform various working such as milling, drilling or notching, boring, tapping, etc. on works set thereto with improved efficiency. A tool holder comprises generally of a tapered portion adapted to be connected to a spindle of a machining center, a manipulator-engaging portion, and a tool holding section for firmly holding the tool.

Most existing cutting tools typically have a round shank which is clamped in a tool holding section of the tool holder by means of a positive lock in the form of a suitable collet chuck or clamping sleeve or heat shrinking the tool in the bore of the tool holding section. While existing positive locking clamping systems for cutting tools for use with machine tools are generally suitable for what is regarded as ordinary performance and heat shrinking is suitable for higher force applications, there is room for improvement in terms of accuracy, rigidity, repeatability.

Many existing machine tools employ some type of coolant system that provides a cutting fluid or lubricant, typically oil, to the workpiece in order to maintain the workpiece at a stable temperature, maximize the life of the cutting tool by lubricating the working edge and reducing tip welding, and to prevent rust on machine parts and cutters. For example, through-tool coolant systems, also known as through-spindle coolant systems, are systems plumbed to deliver coolant through passages inside the spindle and through the tool holder, directly to the cutting interface between the tool and the work piece. Many of these are also high-pressure coolant systems, in which the operating pressure can be hundreds to several thousand psi.

While existing coolant and lubrication systems for machine tools are generally suitable for what is regarded as ordinary performance in connection with existing clamping systems, there is room for improvement in terms of coolant/lubricant delivery for integrated clamping systems that provide for accuracy, rigidity, repeatability and quick change of tools, and which enables high production/cutting rates.

Accordingly, there is a need for an improved tool holder for a through-spindle coolant system that improves performance of the tool.

### SUMMARY

In accordance with one aspect of the present invention, a tool holder connectable to a spindle of a machine having a coolant system and for holding a tool for action against a work piece is disclosed. The tool holder can comprise a first section with a coolant cavity that when attached to the spindle of the machine is in fluid communication with the coolant system of the machine. A tool holding section is integrally formed with the first section and extends longitudinally from the first section to a front face comprising a bore centered on an axis extending co-axially inward from the front face toward the first section for receiving the tool. The tool holding section comprises at least one coolant channel with an opening in the front face that extends inward toward the first section in a helical path around the axis to the coolant cavity of the first section.

In the an embodiment, a plurality of coolant channels can be provided. The coolant channels can extend in counter-clockwise helical paths between a circular channel and the coolant cavity. Openings in the front face can each extending inward toward circular channel. The coolant channels can have a first portion comprising the openings. Preferably, the openings are equally spaced around the bore with a first portion oriented on compound angles with respect to the corresponding openings in the front face. The coolant channels can have a second portion comprising the helical paths. This orientation forms an anti-vibration halo around the bore such that in operation coolant flowing through the counter-clockwise path of the second portion of each of the plurality of coolant channels counter-acts clockwise rotation of the tool holder to dampen vibration.

Further disclosed is a method for manufacturing a tool holder connectable to a spindle of a machine having a coolant system and for holding a tool for action against a work piece. The method comprises utilizing a 3D printing process for integrally forming a first section forming a coolant cavity that when attached to the spindle of the machine is in fluid communication with the coolant system of the machine. The method continues with integrally forming a tool holding section that extends longitudinally from the first section and ends at a front face while forming a bore centered on an axis extending co-axially inward from the front face toward the first section for receiving the tool and while forming at least two coolant channels with a first portion comprising openings in the front face and extending inward toward a circular channel. The helical portions of the coolant channels can extend from the circular channel in helical paths around the axis to the coolant cavity of the first section.

### BRIEF DESCRIPTION OF THE DRAWINGS

These and other features and advantages of the present invention will be better understood by reading the following detailed description, taken together with the drawings wherein:

FIG. 1 is a perspective view of a tool holder according to this disclosure.

FIG. 2 is a side view of the tool holder of FIG. 1.

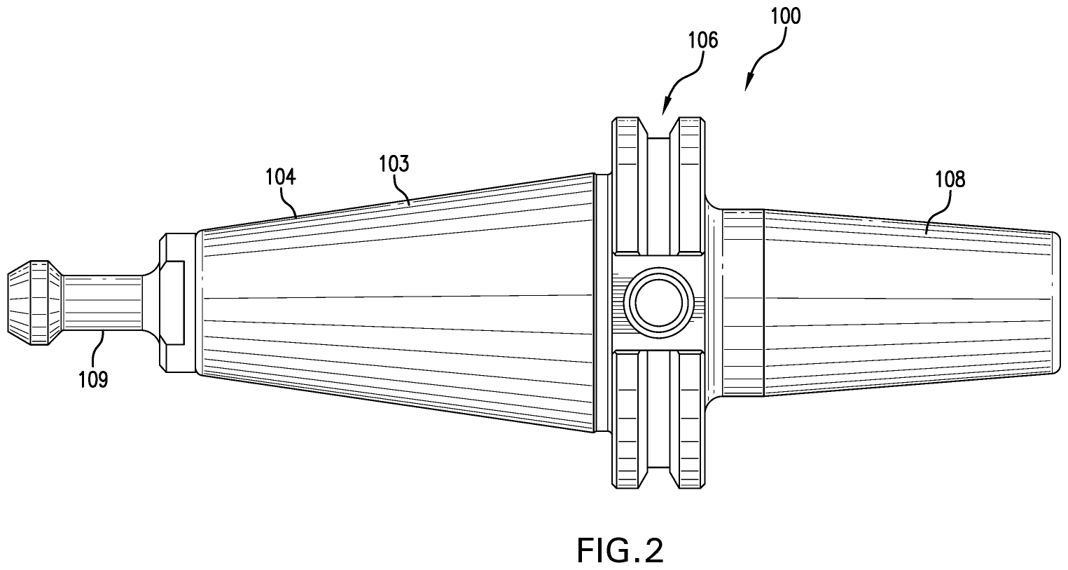

FIG. 3 is a front view of the tool holder of FIG. 1.

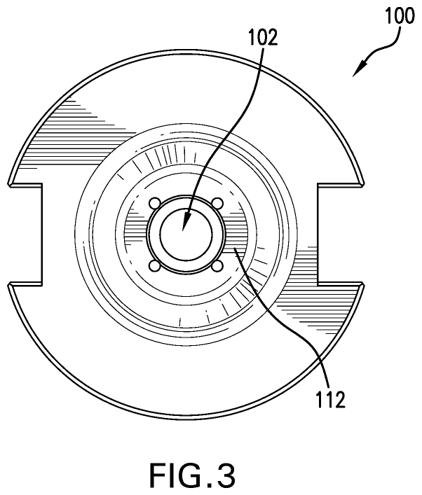

FIG. 4 is a side view of the tool holder of FIG. 1 showing the internal channels.

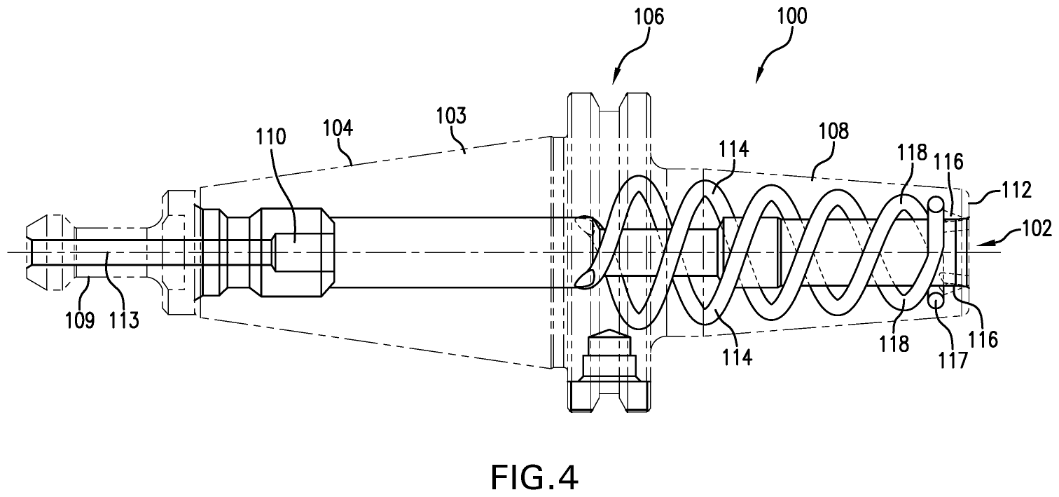

### DETAILED DESCRIPTION OF THE PREFERRED EMBODIMENTS

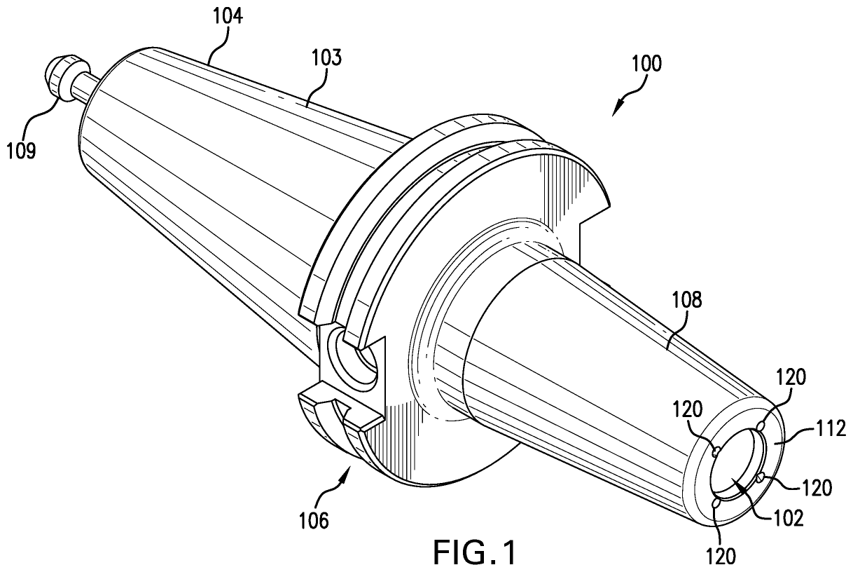

Referring to FIG. 1, disclosed is a tool holder 100 comprising of a first section 103 adapted to be connected to a machine (e.g., a machining center (CNC), lathe, mill, or the like). This first section 103 can include a retention knob 109 at the top with which a connection in the spindle of the machine that holds tool holder 100 in place. A tapered surface 104 extends downward from retention knob 109 to a flange 106 that is designed to be engaged by an automatic tool changer. Finally, a tool holding section 108 can firmly hold a tool in a bore 102 to tool holder 100. A shank of the tool is inserted into bore 102 of tool holding section 108 and secured. While the illustrated embodiment shows a shrink-fit tool holder, those skilled in the art will recognize that any type of tool holder with a through-spindle coolant system can be used; for example, those with positive locks such as a collet chuck, clamping sleeve, end mill holders, arbors, etc.

First section 103 of tool holder 100 comprises of a coolant cavity 110 that extends from the top of retention knob 109 through first section 103 and through tool holding section 108. First section 103 has a tapered surface that can be any standard mill tool holder end, such as cat40, cat50, hsk63, hsk100, etc. Tool holder 100 is inserted into the spindle of the machine, which clamps and holds tool holder 100 by retention knob 109 such that coolant cavity 110 is in fluid communication with the coolant system, which means that coolant from the reservoir is pumped to the machine and into the spindle and directed into coolant cavity 110 through retention knob 109.

Tool holding section 108 is integrally formed and extending longitudinally from first section 103 to a front face 112. Bore 102 is centered front face 112 and on an axis 113 that extends co-axially inward from front face 112 toward first section 103 for receiving the tool in any of the manners described above. Tool holding section 108 comprises of at least one coolant channel 114 comprising a first portion 116 and a second portion 118 with first portion 116 beginning at an opening 120 in front face 112 and extending to a circular channel 117 and second portion 118 extending inward from circular channel 117 of first section 103 in a helical path around axis 113 to coolant cavity 110 of first section 103.

First portion 116 can be oriented on an angle with respect to opening 120 in front face 112. The angle can be a compound angle oriented counter-clockwise. In one implementation, the angle is 15 degrees, in to circular channel 117 and oriented 15 degrees, counterclockwise. Ports 120 of first portion 116 can be canted in to circular channel 117 and back so that the coolant is always contacting the flutes of the tool and rides down on the tool. The preferred range for most standard cutting tools will be between 10 degrees and 60 degrees, inclusive, and any angle in between depending on the length of the cutting tool.

Second portion 118 can define the helical path around axis 113 of bore 102 from circular channel 117 of first portion 116 to coolant cavity 110. The illustrated embodiment shows two coolant channels 114 each dumping into circular channel 117 and arranged helical paths around axis 113. Coolant flows from coolant cavity 110 into coolant channels 114 and flows in a counter-clockwise path around axis 113, which is the opposite direction in which tool holder 100 is being rotated by the spindle, and flows into circular channel 117. Openings 120 of the plurality of coolant channels 114 are equally spaced around the opening of bore 102 with first portion 116 of each of the plurality of coolant channels 114 being positioned on compound angles oriented towards circular channel 117.

The orientation of the plurality of coolant channels 114 and circular channel 117 stops coolant from forming a cone of spray and forms an anti-vibration halo around bore 102 such that in operation coolant flowing through a counter-clockwise helical path around bore 102 counter-acts clockwise rotation of tool holder 100 to dampen vibration while simultaneously directing coolant out openings 120 in front face 112 of tool holder 100. It should also be noted that there is a cooling effect on tool holder 100, itself due to the coolant being evenly distributed through tool holding section 108 during use.

In an embodiment first portion 116 and second portion 118 of coolant channels 114 have internal diameters that correspond to the diameter of standard ports on tool holders in order to retain the same pressure. This means the internal diameters can be 0.118″ to 0.125″ (and any value in between) with it being understood that the diameters can be increased or decreased to lower or raise the coolant pressure.

The complex orientation of coolant channels 114 means that a three-dimensional (3D) printing process is the preferred method of manufacture. The method of manufacture utilizes a 3D printing process to integrally form first section 103 while forming coolant cavity 110. In the conventional 3D printing method this means that coolant cavity 110 is formed from an absence of material while manufacturing first section 103. In other words, the printing head refrains from laying down material in this area.

The 3D printing process continues with integrally forming tool holding section 108 that extends longitudinally from first section 103 and ends at front face 112 while forming bore 102 centered on an axis extending co-axially inward from front face 112 toward first section 103 for receiving the tool and while forming at least one coolant channel 114 of second portion 118. Similarly, bore 102 and coolant channels 114 are formed by refraining from laying down material in the area. This means that the 3D printing process can form bore 102 and coolant channels 114 while printing tool holder 100. Those skilled in the art will recognize that the direction of printing is reversible, the process can begin by forming first section 103 or tool holding section 108.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

We claim:

1. A tool holder connectable to a spindle of a machine having a coolant system and for holding a tool for action against a work piece, the tool holder comprising:
a first section comprising a coolant cavity that when attached to the spindle of the machine is in fluid communication with the coolant system of the machine; and
a tool holding section integrally formed and extending longitudinally from the first section and ending at a front face comprising a bore centered on an axis extending co-axially inward from the front face toward the first section for receiving the tool, wherein the tool holding section comprises at least two coolant channels each connected to the coolant cavity of the first section and each extending in a helical path around the axis toward an opening in the front face.

2. The tool holder of claim 1, and further comprising a circular channel positioned at the end of the helical path of each of the at least two coolant channels and the circular channel connected to at least two openings in the front face.

3. The tool holder of claim 2, wherein the at least two openings are equally spaced around the bore.

4. The tool holder of claim 3, and further comprising a first portion extending from the at least two openings in the front face at an angle to the circular channel.

5. The tool holder of claim 4, and further comprising four openings in the front face and equally spaced around the bore and extending at an angle to the circular channel.

6. The tool holder of claim 5, wherein the at least two coolant channels, the circular channel, and the first portion forms an anti-vibration halo around the bore such that in operation coolant flowing through a counter-clockwise path around the axis counter-acts clockwise rotation of the tool holder to dampen vibration.

7. The tool holder of claim 2, wherein the tool holder is formed by a three-dimensional (3D) printing process.

8. A method for manufacturing a tool holder connectable to a spindle of a machine having a coolant system and for holding a tool for action against a work piece, the method comprising:
utilizing a 3D printing process, integrally forming a first section with a coolant cavity that when attached to the spindle of the machine is in fluid communication with the coolant system of the machine; and
with the 3D printing process integrally forming a tool holding section that extends longitudinally from the first section and ends at a front face while forming a bore centered on an axis extending co-axially inward from the front face toward the first section for receiving the tool and while forming at least two coolant channels each connected to the coolant cavity of the first section and each extending in a helical path around the axis toward an opening in the front face.

9. The method of claim 8, and further comprising forming a circular channel positioned at the end of the helical path of the at least two coolant channels and connecting the circular channel to at least two openings in the front face.

10. The method of claim 9, wherein the at least two openings are equally spaced around the bore.

11. The method of claim 10, further comprising forming a first portion extending from the at least two openings in the front face at an angle to the circular channel.

12. The method of claim 11, and further comprising four openings in the front face each equally spaced around the bore and extending at an angle to the circular channel.

13. The method of claim 12, wherein the at least two coolant channels, the circular channel, and the first portion forms an anti-vibration halo around the bore such that in operation coolant flowing through a counter-clockwise path of the second portion of each of the plurality of coolant channels counter-acts clockwise rotation of the tool holder to dampen vibration.

14. A tool holder connectable to a spindle of a machine having a coolant system and for holding a tool for action against a work piece, the tool holder comprising:
a first section comprising a coolant cavity that when attached to the spindle of the machine is in fluid communication with the coolant system of the machine; and
a tool holding section integrally formed and extending longitudinally from the first section and ending at a front face comprising a bore centered on an axis extending co-axially inward from the front face toward the first section for receiving the tool, wherein the tool holding section comprises: two coolant channels connected to the coolant cavity of the first section and oriented in a helical path around the bore, a circular channel connected to the two coolant channels and extending three-hundred and sixty degrees around the bore; and a plurality of openings extending from the front face to the circular channel.

15. The tool holder of claim 14, and further comprising a plurality of openings equally spaced around the bore on the front face of the tool holding section with each of the plurality of openings comprising channels that are oriented on angles canted and extending to the circular channel.

16. The tool holder of claim 15, wherein the coolant channels are oriented counter-clockwise around the axis, and wherein each of the plurality of openings are angled on substantially fifteen degrees with respect to the axis.

17. The tool holder of claim 16, wherein the tool holding section is formed by a three-dimensional (3D) printing process.
